(19) United States
(12) Patent Application Publication
(10) Pub. No.: US 2013/0345930 A1
(43) Pub. Date: Dec. 26, 2013

(54) Method And Device For Operating a Drive System Having an Accessory Component

(71) Applicants: Andreas BLUMENSTOCK, Ludwigsburg (DE); Nickolaus BENNINGER, Vaihingen/Enz (DE)

(72) Inventors: Andreas BLUMENSTOCK, Ludwigsburg (DE); Nickolaus BENNINGER, Vaihingen/Enz (DE)

(73) Assignee: Robert Bosch GmbH, Stuttgart (DE)

(21) Appl. No.: 13/921,797

(22) Filed: Jun. 19, 2013

(30) Foreign Application Priority Data
Jun. 20, 2012 (DE) 10 2012 210 389.9

(51) Int. Cl. B60H 1/00

(52) U.S. Cl. CPC B60H 1/00771
USPC 701/36

(57) ABSTRACT

A method for operating a drive system for a motor vehicle having an accessory component coupled to a driving motor of the drive system, in particular an air conditioning system, including the following: ascertaining a road resistance of a route section lying ahead in the direction of travel; and adapting a power supplied to the accessory component as a function of the road resistance in the route section ahead of the vehicle; in which the power supplied to the accessory component is adapted as a function of a time period until the route section lying ahead of the vehicle is reached or of a distance from the route section lying ahead of the vehicle.

### RELATED APPLICATION INFORMATION

The present application claims priority to and the benefit of German patent application no. 10 2012 210 389.9, which was filed in Germany on Jun. 20, 2012, the disclosure of which is incorporated herein by reference.

### FIELD OF THE INVENTION

The present invention relates to motor vehicles having a drive system, a driving motor of the drive system providing mechanical power for propelling the motor vehicle and for driving an accessory component such as an air-conditioning system, for example. In particular, the present invention relates to an operating strategy for operating the drive system in instances of limited power availability.

### BACKGROUND INFORMATION

In vehicles having an internal combustion engine, the torque provided by the internal combustion engine is used both for propelling the vehicle as well as for driving accessory components such as air conditioning by an air-conditioning system.

When driving the vehicle, various driving states occur, which demand different driving power outputs of the internal combustion engine for propelling the vehicle. When driving uphill, for example, the required driving power is markedly greater than when driving straight ahead or downhill. If additionally an air-conditioning system is switched on, then additional driving power of the internal combustion engine is requested, which results in a power peak of the requested driving power of the driving motor.

Furthermore, when driving uphill, sufficient driving power should be available such that the vehicle is able to master the uphill stretch if possible without a reduction in speed.

German patent document DE 10 2005 005 002 B4 discusses a method for operating a drive system of a motor vehicle, in which the energy consumption of at least one of the accessory components is throttled when, while driving uphill, less surplus energy is available for operating accessory components.

### SUMMARY OF THE INVENTION

The exemplary embodiments and/or exemplary methods of the present invention provide for a method for operating a drive system having an accessory component as described herein and for a device, a drive system, a computer program and a computer program product as recited in the further coordinated descriptions herein.

Further advantageous developments of the exemplary embodiments and/or exemplary methods of the present invention are indicated in the further descriptions herein.

According to a first aspect, a method is provided for operating a drive system for a motor vehicle having an accessory component mechanically coupled to a driving motor of the drive system, in particular an air-conditioning system. The method includes the following steps:
ascertaining a road resistance of a route section lying ahead in the direction of travel; and
adapting a power supplied to the accessory component as a function of the road resistance in the route section lying ahead of the vehicle, wherein the power supplied to the accessory component is adapted as a function of a time period until the route section lying a head of the vehicle is reached or of a distance from the route section lying ahead of the vehicle.

One idea of the above method is to control the variation of the power consumption of an accessory component as a function of a power requirement for propelling the motor vehicle in such a way that the function or reaction of the accessory component is impaired only negligibly. Particularly suitable for this purposes are accessory components that have a high time constant, such as is the case in an air-conditioning system for conditioning the air in a passenger compartment of the vehicle for example, in which short-term fluctuations of the air-conditioning power output do not become immediately noticeable in a significant change of the interior temperature.

The above method makes it possible for the power of the air-conditioning system to be temporarily adapted in such a way that this does not result in a fluctuation of the temperature of the passenger compartment. On the whole, the above method is based on a prediction of the necessary driving power to be provided for propelling the motor vehicle in the route section lying ahead of the vehicle. This prediction may be made by analyzing a driving path lying ahead of the vehicle and the driving power required for it.

The power supplied to the accessory component may now be adapted in such a way that it is increased in advance if a request of an increased driving power for propelling the vehicle is imminent for a route section lying ahead of the vehicle, or that it is decreased in advance if a request of a reduced driving power is imminent for a route section lying ahead of the vehicle due to a decreasing road resistance. To prevent the adaptation of the power supplied to the accessory component from resulting in an insufficient function of the accessory component (i.e. in an insufficiently high converted power or output power), there may be a provision for reducing the power supplied to the accessory component only if within a short period, i.e. within a time dependent on a time constant of a reaction of the accessory component to the supplied power (response time), a sufficient, in particular increased power may be supplied again to the accessory component, e.g. due to a downhill travel ahead of the vehicle.

Furthermore, the power supplied to the accessory component may be reduced as a function of the road resistance in the route section lying ahead of the vehicle falling below a predetermined second threshold value and the time period until the route section lying ahead of the vehicle is reached being smaller than a predetermined time period.

Furthermore, the power supplied to the accessory component may be increased as a function of the road resistance in the route section lying ahead of the vehicle exceeding a predetermined second threshold value and the time period until the route section lying ahead of the vehicle is reached being smaller than a predefined time period.

There may be a provision for the road resistance of the route section ahead of the vehicle to be ascertained on the basis of an ascent or a descent of the respective route section, the ascent or the descent of the route section ahead of the vehicle being in particular determined using a navigation system or a map provision unit.

According to one specific embodiment, the power supplied to the accessory component may be adapted in such a way that it corresponds on average to a power to be supplied in the route section lying ahead of the vehicle of the same consumed power or output power of the accessory component.

There may be a provision for adapting the power to be supplied to the accessory component only if the road resistance, in the changeover from the currently driven route section to the route section lying ahead of the vehicle, exceeds or falls below a predefined threshold value and if the time period until the route section ahead of the vehicle is reached is smaller than a predefined time duration.

According to another aspect, a device, in particular a processing unit, is provided for operating a drive system for a motor vehicle having an accessory component mechanically coupled to a driving motor of the drive system, in particular an air-conditioning system, the device being developed to:
ascertain a road resistance of a route section lying ahead in the direction of travel;
adapt a power supplied to the accessory component as a function of the road resistance in the route section ahead of the vehicle; and
adapt the power supplied to the accessory component as a function of a time period until the route section lying ahead of the vehicle is reached or of a distance from the route section lying ahead of the vehicle.

According to another aspect, a drive system for a motor vehicle is provided, including:
a driving motor;
an accessory component coupled to the driving motor; and
the above device.

According to another aspect, a computer program having a program code arrangement is provided in order to carry out all steps of the above method when the computer program is executed on a computer or the above device.

According to another aspect, a computer program product is provided, which includes a program code that is stored on a computer-readable data carrier and that implements the above method when it is executed on a data processing device.

Specific embodiments are explained in greater detail below on the basis of the attached drawings.

### BRIEF DESCRIPTION OF THE DRAWINGS

FIG. 1 shows a schematic representation of a vehicle having a drive system and an accessory component.

FIG. 2 shows a flow chart for illustrating a method for operating a drive system for a motor vehicle.

FIG. 3 shows a diagram for illustrating a power supplied to an air-conditioning system when driving uphill and when driving downhill.

### DETAILED DESCRIPTION

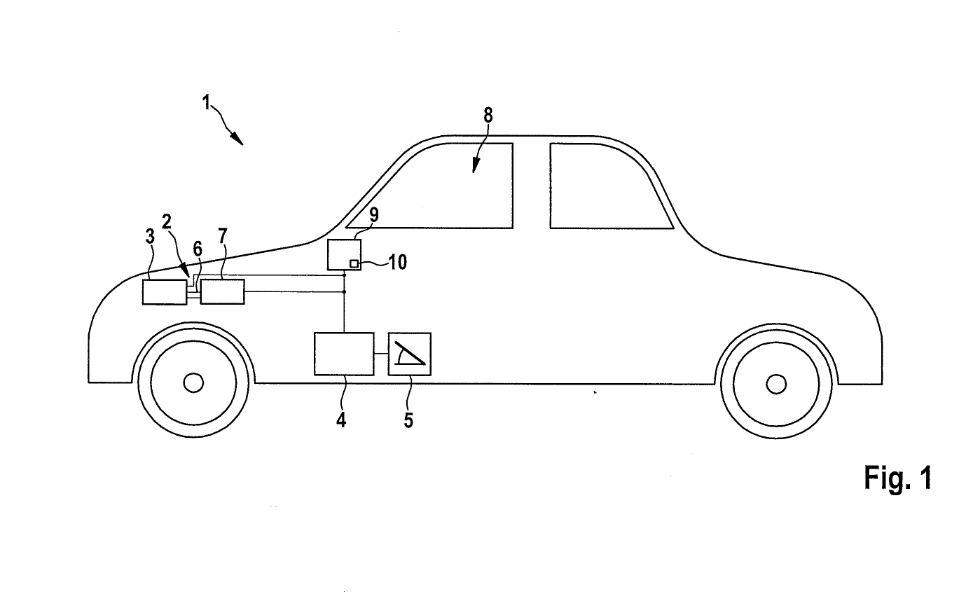

FIG. 1 shows a schematic representation of a motor vehicle 1 having a drive system 2, which has essentially one driving motor 3, e.g. in the form of an internal combustion engine or an electric motor, which is operated by a control unit 4 for supplying an output torque or a motor output.

Control unit 4 receives e.g. information about a torque requested by the driver from an accelerator pedal unit 5, it being possible for the information regarding the torque requested by the driver to be indicated as a position of an accelerator pedal of accelerator pedal unit 5 brought about by a driver of the motor vehicle.

An accessory component 7 is mechanically coupled to an output shaft 6 of driving motor 3 such that accessory component 7 is able to take up mechanical power. In this manner mechanical power is supplied to accessory component 7. An example for such an accessory component 7 is the air-conditioning system that is coupled directly to driving motor 3 and converts the mechanical power into cooling power.

Air-conditioning system 7 is used to cool a passenger compartment 8 of vehicle 1 in a known manner by converting mechanical energy, e.g. with the aid of a suitable heat exchanger (not shown).

Furthermore, vehicle 1 may be equipped with a navigation device 9 or another map provision unit. Navigation device 9 may be developed to provide a driver with route recommendations and to guide the driver along a predefined driving route. For this purpose, navigation device 9 has a route memory 10, which provides route section information about route sections of the driving route. The route section information includes among other things also information about an ascent or a descent of the respective route sections.

When air-conditioning system 7 is active, a portion of the mechanical power provided by driving motor 3 is used, not for propelling the motor vehicle, but rather for operating the accessory component, i.e. the air-conditioning system. This mechanical power is therefore no longer available for driving vehicle 1.

In an uphill drive, which follows upon a drive on a flat route section, there often exists the desire to maintain the driving speed reached when driving on the flat route section or to let this driving speed fall only slightly. Depending on the degree of the ascent, however, the motor power providable by driving motor 3 for driving the ascending route section while the air-conditioning system is switched on may not be sufficient in order to be able to fulfill the request for a uniform speed of the motor vehicle.

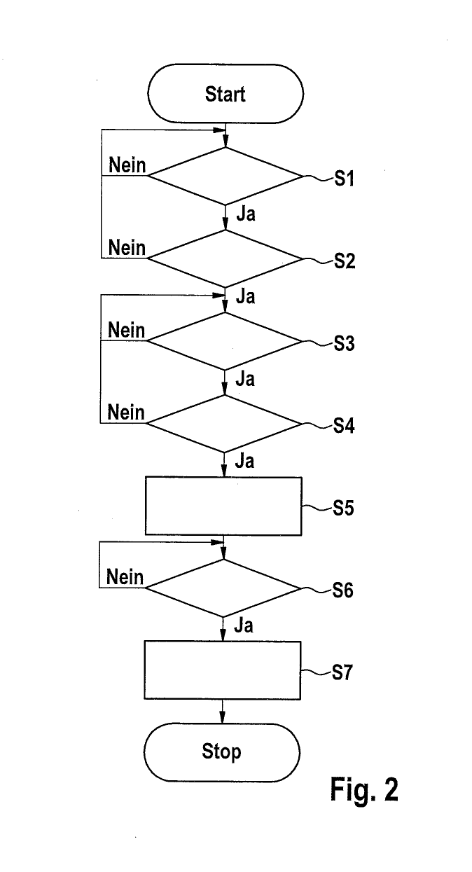

A method for operating the drive system is described in more detail below in connection the flow chart of FIG. 2.

First, a check is performed in step S1 as to whether air-conditioning system 7 is switched on. If this is the case (alternative: yes), then the method is continued with step S2, otherwise (alternative: no) the system reverts to step S1.

A check in now performed in step S2 as to whether the currently driven route section is ascending or whether the road resistance in the route section ahead of the vehicle exceeds a predetermined first threshold value. If this is the case (alternative: yes), then the method is continued with step S3, otherwise (alternative: no) the method reverts to step S1.

In this context, road resistance is understood as the sum of the forces acting on the motor vehicle in addition to the drive torque (driving force), such as the force of friction, the downgrade force, the force of wind and the like, which normally acts counter to the driving force.

A check is now performed in step S3 as to whether the driving speed requested by the driver is also to be maintained in the ascending route section to be driven. If this is the case (alternative: yes), then the method is continued with step S4, otherwise (alternative: no) the method reverts to step S3.

It is possible to derive the intention of the driver to maintain the speed of the vehicle or to accelerate even further from the position of accelerator pedal 5 or from a change of the position of accelerator pedal 5. If the driver, for example, has maintained the position of accelerator pedal 5 when faced with an upcoming ascent, then this may be taken as an indication that the driver would like to maintain the driving speed. If the driver deflects accelerator pedal 5 further, then this may likewise be seen as an indication that the driver at least does not wish to reduce the speed of vehicle 1.

The ascent or the descent of the driven route section may be obtained either from navigation device 9 or the map provision unit, in which the respective information about an ascent or a descent of a particular route section to be driven is stored. Furthermore, the vehicle may be equipped with an inclination sensor, which detects an inclination over the longitudinal axis of the vehicle and provides this to control unit 4 in order to communicate to control unit 4 the current inclination of the roadway.

If it is determined in step S3 that the vehicle is to travel the ascending route section (route section having a road resistance above the predetermined first threshold value) at a uniform or accelerating speed, then a check is performed in step S4 using navigation device 9 as to whether at the current speed of travel the currently traveled route section ends within a predetermined time period and a flat or descending route section follows or generally a route section follows whose road resistance falls below the predetermined second threshold value. If this is the case (alternative: yes), then the method is continued with step S5, otherwise (alternative: no) the method reverts to step S3.

The predetermined time period is chosen in such a way that an absence of the cooling power from the air-conditioning system has no noticeable effects on the temperature of the passenger compartment. A significant increase of the interior temperature becomes noticeable only after some ten seconds to minutes such that due to the great inertia of cooling by an air-conditioning system the predetermined time period may be selected accordingly. Generally, accessory components may be considered for the described method that have a time constant of more than 2 seconds, in particular more than 10 seconds.

Generally, for any accessory component the predetermined time period may be determined as a function of a time constant of the response of the accessory component to the supplied power. If for example a switched-off air-conditioning system would result in a noticeable rise of the interior temperature only after a time of approx. 30 seconds, then the predetermined time period may be fixed at 30 seconds and accordingly the air-conditioning system switched off only if the ascending route section ahead may be traveled within these 30 seconds before a flat or descending route section (a route section having a road resistance below the predetermined second threshold value) follows.

In step S5, the air-conditioning system 7 is switched off or the mechanical energy converted by air-conditioning system 7 into cooling power is reduced.

A query is now made in step S6 as to whether the end of the previously traveled route section has been reached or crossed and whether vehicle 1 is again on a flat route section, a descending route section or a route section having a road resistance below the predetermined second threshold value. If this is the case (alternative: yes), then the method is continued with step S7, otherwise (alternative: no) the method reverts to step S6.

Air-conditioning system 7 is switched on in step S7 or the cooling power of the air-conditioning system is increased in order to prevent the interior temperature of the passenger compartment from rising. In a descending route section (a route section having a road resistance below the predetermined second threshold value), the cooling power may then be obtained from the potential energy converted into kinetic energy. Subsequently the method is terminated.

Alternatively or additionally, in the event of a descending route section (a route section having a road resistance below the predetermined second threshold value) there may be a provision for the cooling power to be increased with respect to the specified cooling in order to provide an increased cooling power that will likewise become noticeable only after a certain time period due to the inertia of the cooling system. In this manner, on the one hand, it is possible to compensate for a warming of passenger compartment 8 due to a reduced cooling power because of the previous travel on an ascending route section (a route section having a road resistance above the predetermined first threshold value).

On the other hand, in an ascending route section (a route section having a road resistance above the predetermined first threshold value) lying ahead of the vehicle, it is possible to request an increased cooling power, which due to the inertia of the cooling system does not immediately result in a noticeable lowering of the interior temperature of passenger compartment 8 and which is compensated for by the reduced cooling power while traveling on the subsequent ascending route section. In other words, when it is established that an ascending route section or a route section having a road resistance above the predetermined first threshold value is imminent, then the cooling power may be increased even on a flat route section (a route section having a road resistance below the predetermined second threshold value) if it is recognized that the ascending route section or route section having a road resistance above the predetermined first threshold value lying ahead of the vehicle may be traveled within the predetermined time period. In the transition to the respective ascending route section, air conditioning system 7 may then be shut off or its cooling power be reduced such that in combination with the previously requested increased cooling power and the now reduced cooling power on average the desired cooling power is obtained for maintaining the interior temperature of vehicle 1 desired by the driver.

The predetermined first and second threshold values may be identical or form a range, in which the road resistance indicates neither a significant ascent nor a significant descent.

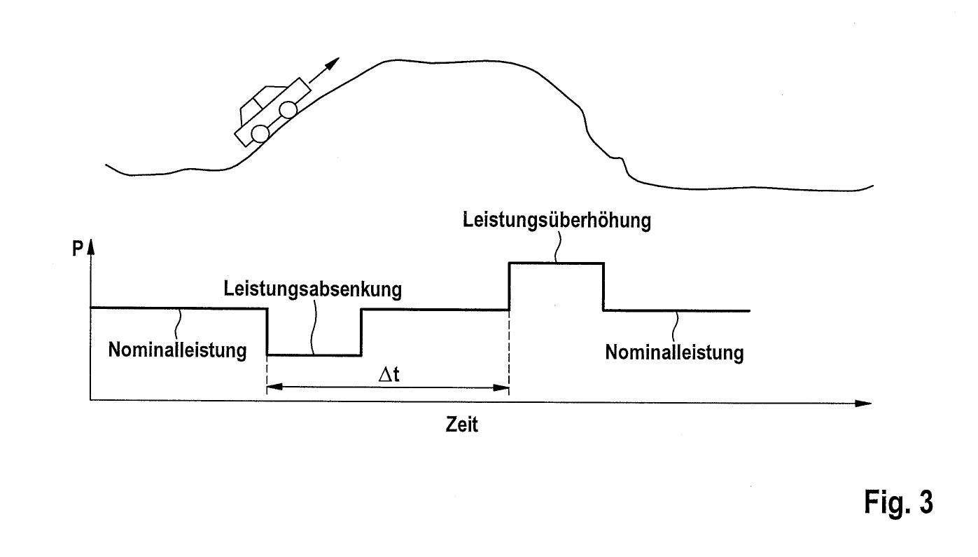

FIG. 3 shows the curve of the cooling power P provided to air conditioning system 7 while traveling an ascending route section, a flat route section and a descending route section. It may be seen that in ascending route sections, which do not exceed a certain length (i.e. a length that may be traveled at the current vehicle speed within the predetermined time period Δt), cooling power P of air conditioning system 7 may be lowered in order to provide additional driving power. The cooling power that is missing for the purpose of cooling may then be additionally requested already when traveling on a flat route section or when traveling on a descending route section in order prevent the interior temperature of the passenger compartment from rising noticeably. The adaptation of cooling powers P occurs in such a way that an average cooling power is achieved that corresponds to the desired cooling power.

What is claimed is:

1. A method for operating a drive system for a motor vehicle, having an accessory component coupled to a driving motor of the drive system, in particular an air conditioning system, the method comprising:
ascertaining a road resistance of a route section lying ahead in the direction of travel; and
adapting a power supplied to the accessory component as a function of the road resistance in the route section lying ahead of the vehicle;
wherein the power supplied to the accessory component is adapted as a function of a time period until the route section lying a head of the vehicle is reached or a distance from the route section lying ahead of the vehicle.

2. The method of claim 1, wherein the power supplied to the accessory component is reduced as a function of the road resistance in the route section lying ahead of the vehicle falling below a predetermined second threshold value and of the time period until the route section lying ahead of the vehicle is reached being smaller than a predetermined time period.

3. The method of claim 1, wherein the power supplied to the accessory component is increased as a function of the road resistance in the route section lying ahead of the vehicle exceeding a predetermined second threshold value and of the time period until the route section lying ahead of the vehicle is reached being smaller than a predefined time period.

4. The method of claim 1, wherein the road resistance of the route section ahead of the vehicle is ascertained on the basis of an ascent or a descent of the respective route section, the ascent or the descent of the route section ahead of the vehicle being in particular determined using a navigation system or a map provision unit.

5. The method of claim 1, wherein the power supplied to the accessory component is adapted in such a way that it corresponds on average to a power to be supplied in the route section lying ahead of the vehicle of the same consumed power or output power of the accessory component.

6. The method of claim 1, wherein the power to be supplied to the accessory component is adapted only if the road resistance, in the change from the currently traveled route section to the route section lying ahead of the vehicle, exceeds or falls below a predetermined threshold value and if the time period until the route section ahead of the vehicle is reached is smaller than a predetermined time period.

7. A device for operating a drive system for a motor vehicle having an accessory component mechanically coupled to a driving motor of the drive system, in particular an air conditioning system, comprising:
a processing unit configured to ascertain a road resistance of a route section lying ahead of the vehicle, adapt a power supplied to the accessory component as a function of the road resistance in the route section ahead of the vehicle, and to adapt the power supplied to the accessory component as a function of a time period until the route section lying ahead of the vehicle is reached or of a distance from the route section lying ahead of the vehicle.

8. The device of claim 7, wherein the power supplied to the accessory component is reduced as a function of the road resistance in the route section lying ahead of the vehicle falling below a predetermined second threshold value and of the time period until the route section lying ahead of the vehicle is reached being smaller than a predetermined time period.

9. A drive system for a motor vehicle, comprising:
a driving motor;
an accessory component coupled to the driving motor; and
a device for operating a drive system arrangement for the motor vehicle having the accessory component mechanically coupled to the driving motor of the drive system arrangement, in particular an air conditioning system, including a processing unit configured to ascertain a road resistance of a route section lying ahead of the vehicle, adapt a power supplied to the accessory component as a function of the road resistance in the route section ahead of the vehicle, and to adapt the power supplied to the accessory component as a function of a time period until the route section lying ahead of the vehicle is reached or of a distance from the route section lying ahead of the vehicle.

10. A computer readable medium having a computer program, which is executable by a processor, comprising:
a program code arrangement having program code for operating a drive system for a motor vehicle, having an accessory component coupled to a driving motor of the drive system, in particular an air conditioning system, by performing the following:
ascertaining a road resistance of a route section lying ahead in the direction of travel; and
adapting a power supplied to the accessory component as a function of the road resistance in the route section lying ahead of the vehicle;
wherein the power supplied to the accessory component is adapted as a function of a time period until the route section lying a head of the vehicle is reached or a distance from the route section lying ahead of the vehicle.
